(19) United States
(12) Patent Application Publication
(10) Pub. No.: US 2006/0187493 A1
(43) Pub. Date: Aug. 24, 2006

(54) Image scanning method and apparatus capable of effectively securing illumination intensity

(76) Inventor: Masanobu Yamagata, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/357,018

(22) Filed: Feb. 21, 2006

(30) Foreign Application Priority Data
Feb. 18, 2005 (JP) 2005-042613

(51) Int. Cl. H04N 1/23

(52) U.S. Cl. 358/302

(57) ABSTRACT

An image scanning apparatus scans an image formed on a surface of a document. The image scanning apparatus includes a contact glass, a plurality of moving members including a light source and a plurality of reflection mirrors, an imaging lens, and an image pickup device. The contact glass holds the document thereon. The plurality of moving members are provided below the contact glass and move in a sub-scanning direction. The light source outputs light for illuminating the surface of the document. The plurality of reflection mirrors sequentially reflect the light reflected obliquely from the surface of the document. The imaging lens collects the reflected light. The image pickup device forms thereon an image from the light output from the imaging lens.

### CROSS REFERENCE TO RELATED APPLICATION

This application claims priority to Japanese patent application no. 2005-042613 filed on Feb. 18, 2005, the entire contents of which are hereby incorporated by reference herein.

### BACKGROUND OF THE INVENTION

1. Field of the Invention

The present invention relates to an image scanning method and apparatus for scanning an image on a document by applying light output from a light source to the document and guiding a reflected light from the document through an imaging lens to an image pickup device to form an image thereon.

2. Description of the Background Art

FIGS. 1 and 2 illustrate a background image scanning apparatus 1. The image scanning apparatus 1 includes a contact glass 2, a first moving member 3, a second moving member 4, an imaging lens 5, a one-dimensional CCD (charge-coupled device) 6, a reflector 7, a lamp 8, and reflection mirrors 9, 10, and 11.

In the image scanning apparatus 1, a document S carrying thereon an image to be scanned is placed on the contact glass 2. The first moving member 3 and the second moving member 4 are provided below the contact glass 2, and are driven by a motor (not illustrated) to move in a sub-scanning direction (i.e., a direction indicated by an arrow Y in FIGS. 1 and 2). The one-dimensional CCD 6 is an image pickup device extending in a main-scanning direction, (i.e., a direction indicated by an arrow X in FIGS. 1 and 2 or a direction perpendicular to the drawing surface). The lamp 8 is a light source for applying light to the contact glass 2 directly or by the reflector 7 to illuminate a scanning region (i.e., an imaging region) ds of the document S. The lamp 8 and the reflection mirror 9 are provided as part of the first moving member 3. Meanwhile, the reflection mirrors 10 and 11 are provided as part of the second moving member 4. The lamp 8 and the reflection mirrors 9, 10, and 11 extend in the main-scanning direction.

The light output from the lamp 8 is reflected by the document S, and transmits to the contact glass 2. Then, the light is reflected by the reflection mirrors 9, 10, and 11, and is formed into an image on the CCD 6 by the imaging lens 5. This process is repeated while the first and second moving members 3 and 4 are moving in the sub-scanning direction. Thereby, images of minute scanning regions are sequentially accumulated, and the entire image on the document S is two-dimensionally acquired by the CCD 6.

In the image scanning apparatus 1, the reflection mirrors 9, 10, and 11 are placed at an angle of approximately forty-five degrees with respect to a surface of the document S (i.e., a surface 12 of the contact glass 2). Thus, optical axes of a scanning optical system through which the reflected light from the document S passes (i.e., scanning optical axes) are either parallel or perpendicular to the surface of the document S. To increase illumination intensity of the scanning region ds, the lamp 8 is preferably provided such that the distance between the lamp 8 and the scanning region ds is reduced as much as possible. That is, the lamp 8 is preferably provided such that an illuminating optical axis L1 extending directly from the lamp 8 to the contact glass 2, which is one of illuminating optical axes, i.e., optical axes of an illuminating optical system through which the illuminating light to the document S passes, is as perpendicular to the surface of the document S as possible, i.e., that an incident angle θ (theta) of the illuminating optical axis L1 (illustrated in FIG. 2) with respect to the surface of the document S is reduced as much as possible.

If the lamp 8 is placed close to the scanning region ds, however, the lamp 8 is also close to a scanning optical axis R1 (i.e., an optical axis extending from the surface of the document S to the reflection mirror 9 provided as part of the first moving member 3). Therefore, the lamp 8 may touch the contact glass 2 or block an optical path of the scanning optical system due to such factors as slight size errors in components and vibration caused by movement of the first moving member 3 and the second moving member 4. As a result, a jitter may occur in a scanned image. Further, the illumination intensity of the scanning region ds may become insufficient to cause a defective scanning operation and degradation in quality of a background image.

In light of the above, a lamp having relatively high brightness intensity may be used to maintain a certain distance between the lamp and the scanning region ds. However, such a lamp is relatively expensive and consumes a relatively large amount of power. Further, there is a technical limit in increasing the brightness intensity of the lamp.

In view of this, there is another background image scanning apparatus in which a lamp is placed above a contact glass. This background image scanning apparatus can scan a transparent document but not a reflective document. Further, an upper part of the background image scanning apparatus is increased in size, and the number of components forming the background image scanning apparatus is increased. As a result, cost of the background image scanning apparatus increases.

### SUMMARY OF THE INVENTION

This patent specification describes an image scanning apparatus for scanning an image formed on a surface of a document. In one example, an image scanning apparatus for scanning an image formed on a surface of a document includes a contact glass, a plurality of moving members, an imaging lens, and an image pickup device. The contact glass is configured to hold the document thereon. The plurality of moving members are provided below the contact glass and are configured to move in a sub-scanning direction. The plurality of moving members includes a light source and a plurality of reflection mirrors. The light source is configured to output light for illuminating the surface of the document. The plurality of reflection mirrors are configured to sequentially reflect the light reflected obliquely from the surface of the document. The imaging lens is configured to collect the reflected light. The image pickup device is configured to form thereon an image from the light output from the imaging lens.

This patent specification further describes another image scanning apparatus for scanning an image formed on a surface of a document. In one example, the another image scanning apparatus for scanning an image formed on a surface of a document includes document holding means, moving means, imaging means, and image pickup means. The document holding means holds the document thereon. The moving means moves below the document holding means in a sub-scanning direction. The moving means includes light source means for outputting light for illuminating the surface of the document, and reflecting means for sequentially reflecting the light reflected obliquely from the surface of the document. The imaging means collects the reflected light. The image pickup means forms thereon an image from the light output from the imaging means.

This patent specification further describes an image scanning method for scanning an image formed on a surface of a document. In one example, an image scanning method for scanning an image formed on a surface of a document includes: placing a document on a contact glass; moving a plurality of moving members below the contact glass in a sub-scanning direction; outputting light from a light source for illuminating the surface of the document; sequentially reflecting the light reflected obliquely from the surface of the document by a plurality of reflection mirrors; and focusing the reflected light through an imaging lens to an image pickup device to form an image thereon.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic sectional view of an optical system in a background image scanning apparatus;

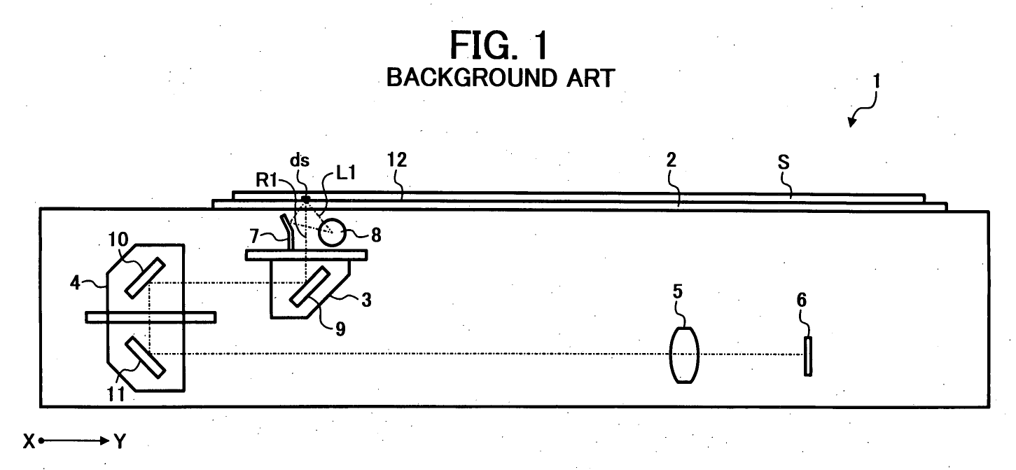

FIG. 2 is an enlarged view of a part near the first moving member in the image scanning apparatus illustrated in FIG. 1;

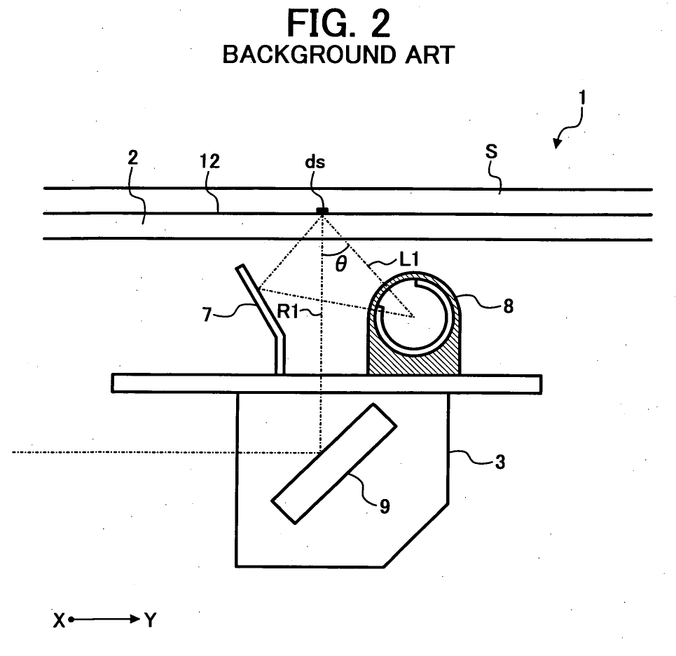

FIG. 3 is a perspective view of an image scanning apparatus according to an embodiment of the present invention;

FIG. 4 is a schematic sectional view of an optical system in the image scanning apparatus illustrated in FIG. 3;

FIG. 5 is an enlarged view of a part near the first moving member in the image scanning apparatus illustrated in FIG. 4;

FIG. 6 is a graph indicating illumination intensity distribution curves with respect to a document surface, measured for the background image scanning apparatus illustrated in FIG. 1 and the image scanning apparatus illustrated in FIG. 3; and

FIG. 7 is an enlarged view of a part near the first moving member in an image scanning apparatus according to another embodiment of the present invention.

### DETAILED DESCRIPTION OF THE PREFERRED EMBODIMENTS

In describing the embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner.

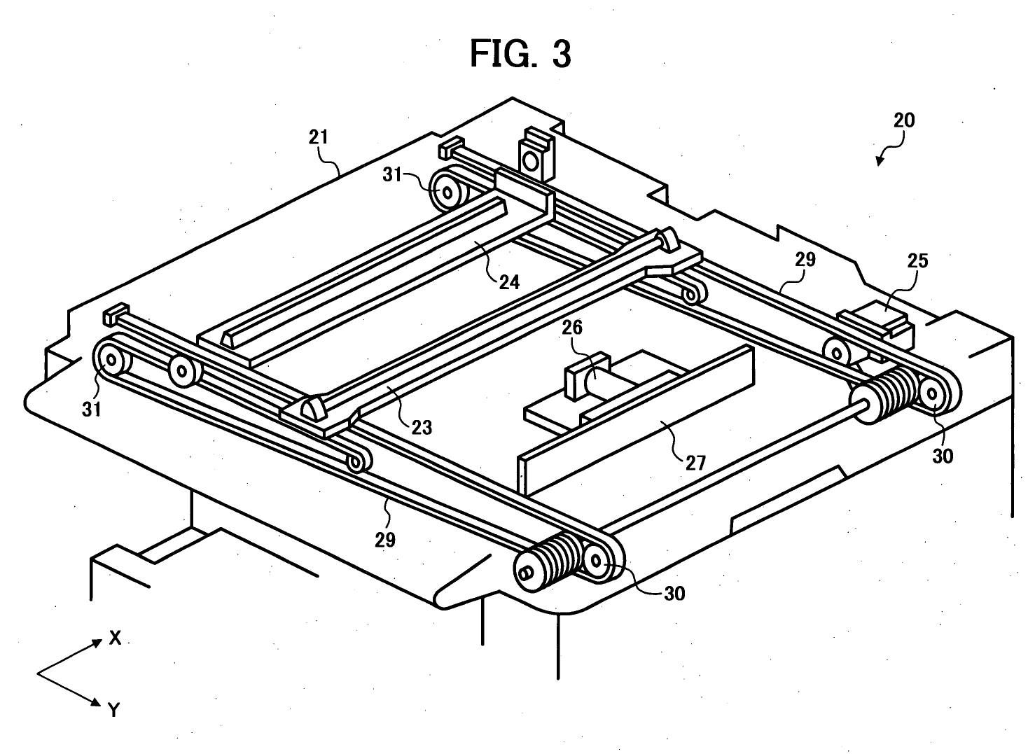

Referring now to the drawings, wherein like reference numerals designate identical or corresponding parts throughout the several views, particularly to FIGS. 3 to 5, a configuration and functions of an image scanning apparatus 20 according to an exemplary embodiment of the present invention are described.

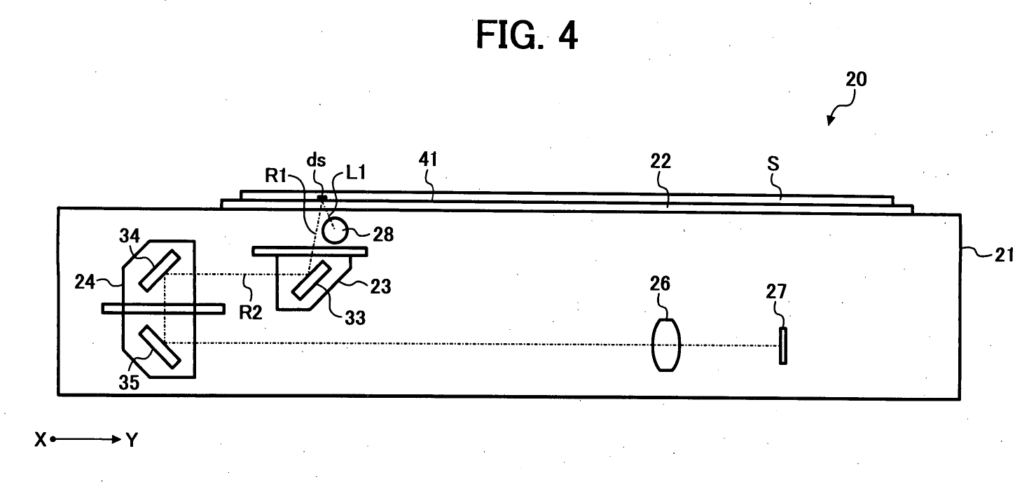

As illustrated in FIGS. 3 and 4, the image scanning apparatus 20 includes a box-shaped housing 21, a contact glass 22, a first moving member 23, a second moving member 24, a motor 25, an imaging lens 26, a one-dimensional CCD 27 functioning as an image pickup device, a lamp 28, scan belts 29, pulleys 30 and 31, and reflection mirrors 33, 34, and 35.

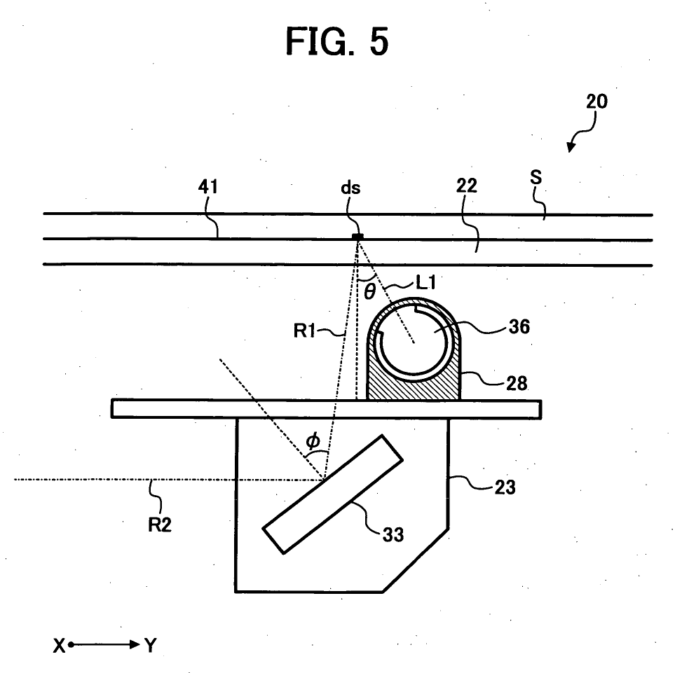

As illustrated in FIGS. 4 and 5, the contact glass 22 is placed on an upper surface of the housing 21, and a document S carrying thereon an image to be scanned is placed on the contact glass 22. The first and second moving members 23 and 24 are movably provided below the contact glass 22 in the sub-scanning direction (i.e., the direction indicated by the arrow Y). Further, the first and second moving members 23 and 24 are fastened onto the scan belts 29 that extend in the sub-scanning direction. The scan belts 29 are extended between the pulleys 30 and 31. As a driving force for the motor 25 is transmitted to the pulleys 30, the pulleys 30 are rotated. Thereby, the scan belts 29 move, and the first and second moving members 23 and 24 move in the sub-scanning direction.

As illustrated in FIG. 4, the first moving member 23 is provided with the reflection mirror 33 and the lamp 28 functioning as a light source. Meanwhile, the second moving member 24 is provided with the reflection mirror 34 for receiving a light reflected by the reflection mirror 33, and the reflection mirror 35 for receiving a light reflected by the reflection mirror 34. The lamp 28 provided as part of the first moving member 23 is formed by a small-sized elongated fluorescent light (e.g., a backlight fluorescent tube) or an LED (light-emitting diode), for example, and extends in the main-scanning direction. The lamp 28 has an output aperture 36 (illustrated in FIG. 5) from which illuminating light is output to the document S and that extends in the main-scanning direction.

The lamp 28 is preferably set such that, on a surface of the document S (i.e., a surface 41 of the contact glass 22), a scanning region (i.e., an imaging region) ds on the document S substantially overlaps, in the sub-scanning direction, a peak position in an illumination intensity distribution of the illuminating light output from the lamp 28 (i.e., a position in an illumination area or an illuminating range illuminated by the lamp 28 having the highest illumination intensity). Specifically, within the scanning region ds, the surface of the document S intersects with an illuminating optical axis L1 extending from the lamp 28 to the contact glass 22 (i.e., a line connecting the radial center of the lamp 28 with the circumferential center of the output aperture 36, and the extended line of the line). Accordingly, the position of the highest illumination intensity in the illumination area of the lamp 28 substantially overlaps the scanning region ds. Accordingly, an illumination intensity necessary for scanning the image on the document S is effectively obtained.

The imaging lens 26 is placed to receive a light reflected by the reflection mirror 35 provided as part of the second moving member 24. The CCD 27 is placed at an image forming position of the imaging lens 26. The CCD 27 includes a plurality of CCD pixels arranged in a line. Each of the reflection mirrors 33, 34, and 35, and the CCD 27 is formed into an elongated shape and extends in the main-scanning direction (i.e., the direction indicated by the arrow X in FIGS. 3 to 5).

In the image scanning apparatus 20, an illuminating light flux output from the lamp 28 penetrates the contact glass 22 and directly illuminates the scanning region ds on the document S. The illuminating light on the document S is reflected according to the density of the image on the document S. The light thus reflected penetrates the contact glass 22 again, and is reflected and guided by the reflection mirrors 33, 34, and 35 to the imaging lens 26. Then, the light is formed into an image on the CCD 27, and the image is scanned. A sequence of these operations is performed while the first and second moving members 23 and 24 move in the sub-scanning direction with the image forming position with respect to the surface of the document S being kept on the CCD 27. Accordingly, the two-dimensional image carried on the document S is picked up.

The reflection mirrors 34 and 35 provided as part of the second moving member 24 are placed at an angle of approximately forty-five degrees with respect to the surface of the document S. Meanwhile, the reflection mirror 33 provided as part of the first moving member 23 is placed at an angle changeable with respect to the surface of the document S. Specifically, the angle of the reflection mirror 33 is adjusted such that a scanning optical axis R1 extending from the surface of the document S to the reflection mirror 33 provided as part of the first moving member 23 is not perpendicular to the surface of the document S but is tilted away from the lamp 28 so as not to touch the lamp 28. Further, the angle of the reflection mirror 33 is adjusted such that a scanning optical axis R2 extending from the reflection mirror 33 to the reflection mirror 34 provided to the second moving member 24 is substantially parallel to the surface of the document S. That is, the angle of the reflection mirror 33 is adjusted such that an incident angle φ (phi) of the scanning optical axis R1 with respect to the reflection mirror 33 provided to the first moving member 23 becomes larger than forty-five degrees.

As described above, in the image scanning apparatus 20, the scanning optical axis R1 (i.e., the light reflected from the surface of the document S) is tilted away from the lamp 28. In the image scanning apparatus 20, therefore, the scanning region ds is closer to the lamp 28 than in the background image scanning apparatus 1 in which the scanning optical axis R1 is perpendicular to the surface of he document S. Thus, the incident angle θ of the illuminating optical axis L1 with respect to the surface of the document S can be reduced in the image scanning apparatus 20. According to the image scanning apparatus 20, therefore, the illumination intensity of the scanning region ds can be easily increased to a higher level than the background image scanning apparatus 1.

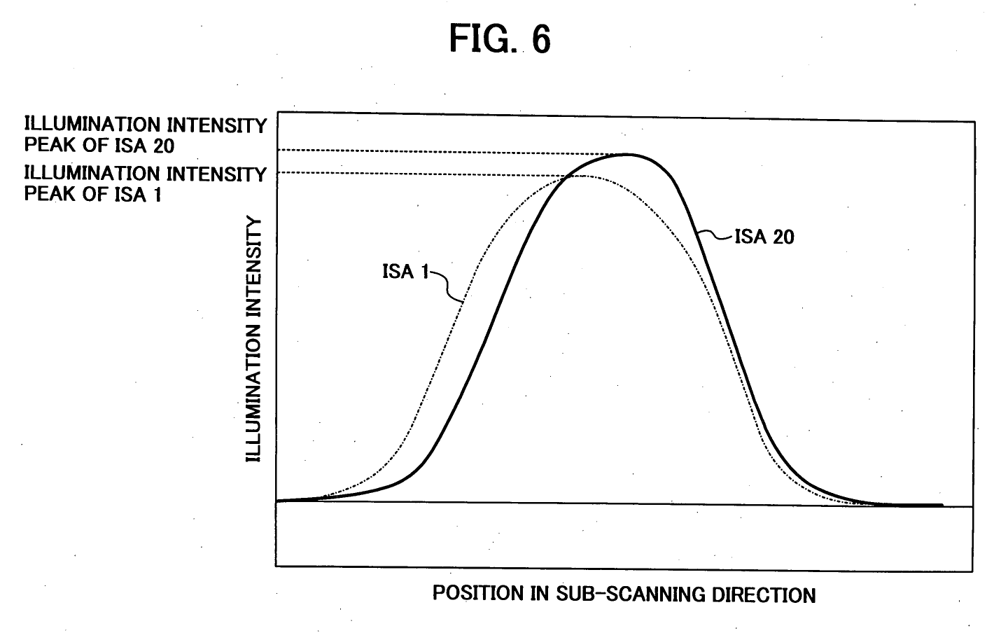

Since a tilt angle of the reflection mirror 33 is changed, the width of the scanning region ds in the sub-scanning direction is larger in the image scanning apparatus 20 than in the background image scanning apparatus 1. With the amount of light applied to illuminate the scanning region ds being unchanged, the illumination intensity decreases as the width of the scanning region ds in the sub-scanning direction increases. In this regard, the illumination intensity decreases in the image scanning apparatus 20. However, a decrease in the illumination intensity due to the change in the width of the scanning region ds in the sub-scanning direction is relatively small compared with an increase in the illumination intensity due to the change in the incident angle of the light with respect to the surface of the document S. FIG. 6 is a graph representing distribution curves of the illumination intensity on the surface of the document S measured for the image scanning apparatus 20 (indicated as ISA 20 in FIG. 6) and the background image scanning apparatus 1 (indicated as ISA 1 in FIG. 6). As observed from the graph, the peak of the illumination intensity (i.e., the illumination intensity of the scanning region ds) is higher in the image scanning apparatus 20 than in the background image scanning apparatus 1.

In the image scanning apparatus 20 according to the present embodiment, the light output from the lamp 28 illuminates the surface of the document S, and the light reflected obliquely from the surface of the document S is reflected by the reflection mirror 33. Therefore, the incident angle θ of the illuminating optical axis L1 with respect to the surface of the document S can be reduced, and thus the lamp 28 can be placed closer to the scanning region ds. Thereby, the illumination intensity of the scanning region ds can be increased. According to the image scanning apparatus 20, therefore, illumination efficiency is increased to decrease power consumption. Further, the illumination intensity necessary for the scanning region ds is obtained, and thus a high-quality image scanning operation can be performed.

The image scanning apparatus 20 has a relatively simple structure in which the tilt of the reflection mirror 33 is adjusted. Thus, unlike background image scanning apparatuses, a lamp having a relatively high brightness intensity is unnecessary, and the size of the upper portion of the image scanning apparatus 20 and the number of components forming the image scanning apparatus 20 are not increased. Accordingly, the image scanning apparatus 20 can be manufactured at relatively low cost, and can decrease power consumption.

Further, the image scanning apparatus 20 is versatile, being capable of scanning reflective documents as well as transparent documents.

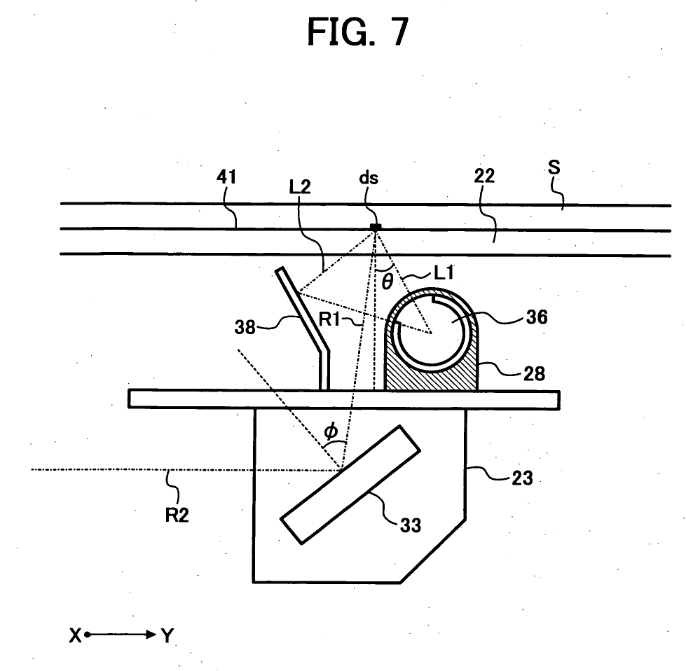

The image scanning apparatus 20 is not limited to the example described above. For example, as illustrated in FIG. 7, a reflector 38 may be added to the first moving member 23 for reflecting the illuminating light output from the lamp 28 in the direction of the contact glass 22. The reflector 38 is placed opposite to the lamp 28 such that a part of the illuminating light output from the lamp 28 but not directly advancing to the surface of the document S is reflected by the reflector 38 onto the surface of the document S. Accordingly, the light output from the lamp 28 can be effectively used.

The reflector 38 may be preferably placed such that the surface of the document S intersects, in the scanning region ds, with an illuminating optical axis L2 extending from the lamp 28 to the contact glass 22 guided by the reflector 38, i.e., that the peak position in the illumination intensity distribution of the illuminating light reflected by the reflector 38 substantially overlaps the scanning region ds in the sub-scanning direction on the surface of the document S. Accordingly, the illumination intensity of the scanning region ds can be further effectively obtained.

The above-described embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of this patent specification may be practiced otherwise than as specifically described herein.

1. An image scanning apparatus for scanning an image formed on a surface of a document, the image scanning apparatus comprising:
a contact glass configured to hold the document thereon;
a plurality of moving members provided below the contact glass and configured to move in a sub-scanning direction, the plurality of moving members including
a light source configured to output light for illuminating the surface of the document, and
a plurality of reflection mirrors configured to sequentially reflect the light reflected obliquely from the surface of the document;
an imaging lens configured to collect the reflected light; and
an image pickup device configured to form thereon an image from the light output from the imaging lens.

2. The image scanning apparatus according to claim 1, wherein the light reflected obliquely from the surface of the document impinges on one of the plurality of reflection mirrors at an incident angle greater than forty-five degrees, and is reflected by the one of the plurality of reflection mirrors substantially parallel to the surface of the document.

3. The image scanning apparatus according to claim 2, wherein the light output from the light source substantially overlaps a scanning region on the surface of the document in the sub-scanning direction.

4. The image scanning apparatus according to claim 3, wherein the plurality of moving members further include a reflector configured to reflect the light output from the light source onto the contact glass such that the light substantially overlaps the scanning region on the surface of the document in the sub-scanning direction.

5. The image scanning apparatus according to claim 1, wherein the plurality of moving members include a first moving member including the light source and a first reflection mirror and a second moving member including second and third reflection mirrors.

6. The image scanning apparatus according to claim 1, wherein the light reflected obliquely from the surface of the document impinges on the first reflection mirror at an incident angle greater than forty-five degrees, and is reflected by the first reflection mirror substantially parallel to the surface of the document.

7. The image scanning apparatus according to claim 6, wherein the light output from the light source substantially overlaps a scanning region on the surface of the document in the sub-scanning direction.

8. The image scanning apparatus according to claim 7, wherein the first moving member further includes a reflector configured to reflect the light output from the light source onto the contact glass such that the light substantially overlaps the scanning region on the surface of the document in the sub-scanning direction.

9. An image scanning apparatus for scanning an image formed on a surface of a document, the image scanning apparatus comprising:
document holding means for holding the document thereon;
moving means for moving below the document holding means in a sub-scanning direction, the moving means including,
light source means for outputting light for illuminating the surface of the document, and
reflecting means for sequentially reflecting the light reflected obliquely from the surface of the document;
imaging means for collecting the reflected light; and
image pickup means for forming thereon an image from the light output from the imaging means.

10. The image scanning apparatus according to claim 9, wherein the light reflected obliquely from the surface of the document enters the reflecting means at an incident angle greater than forty-five degrees, and is reflected by the reflecting means substantially parallel to the surface of the document.

11. The image scanning apparatus according to claim 10, wherein the light output from the light source means substantially overlaps a scanning region on the surface of the document in the sub-scanning direction.

12. The image scanning apparatus according to claim 11, wherein the moving means further includes reflecting means for reflecting the light output from the light source onto the document holding means such that the light substantially overlaps the scanning region on the surface of the document in the sub-scanning direction.

13. The image scanning apparatus according to claim 9, wherein the moving means includes a first moving member including the light source means and a first reflection means and a second moving member including second and third reflection means.

14. The image scanning apparatus according claim 13, wherein the light reflected obliquely from the surface of the document impinges on the first reflection means at an incident angle greater than forty-five degrees, and is reflected by the first reflection means substantially parallel to the surface of the document.

15. The image scanning apparatus according to claim 14, wherein the light output from the light source means substantially overlaps a scanning region on the surface of the document in the sub-scanning direction.

16. The image scanning apparatus according to claim 15, wherein the first moving member further includes reflection means for reflecting the light output from the light source means onto the contact glass such that the light substantially overlaps the scanning region on the surface of the document in the sub-scanning direction.

17. An image scanning method for scanning an image formed on a surface of a document, the image scanning method comprising:
placing a document on a contact glass;
moving a plurality of moving members below the contact glass in a sub-scanning direction;
outputting light from a light source for illuminating the surface of the document;
sequentially reflecting the light reflected obliquely from the surface of the document by a plurality of reflection mirrors; and
focusing the reflected light through an imaging lens to an image pickup device to form an image thereon.

18. The image scanning method according to claim 17, wherein the sequentially reflecting comprises:
directing the light reflected obliquely from the surface of the document to one of the plurality of reflection mirrors at an incident angle greater than forty-five degrees; and
directing the light reflected by the one of the plurality of reflection mirrors substantially parallel to the surface of the document.

19. The image scanning method according to claim 18, wherein the outputting comprises:
directing the light output from the light source to the surface of the document such that the light substantially overlaps a scanning region on the surface of the document in the sub-scanning direction.

20. The image scanning method according to claim 19, wherein the outputting further comprises:
reflecting the light output from the light source to the contact glass by a reflector such that the light substantially overlaps the scanning region onto the surface of the document in the sub-scanning direction.

21. The image scanning method according to claim 17, wherein the sequentially reflecting includes reflecting the light off a first reflection mirror of a first moving member of the plurality of moving members, and off of second and third reflection mirrors of a second moving member of the plurality of moving members.

22. The image scanning method according to claim 17, wherein the sequentially reflecting comprises:
directing the light reflected obliquely from the surface of the document to the first reflection mirror at an incident angle greater than forty-five degrees; and
directing the light reflected by the first reflection mirror substantially parallel to the surface of the document.

23. The image scanning method according to claim 22, wherein the outputting comprises:
directing the light output from the light source to the surface of the document such that the light substantially overlaps a scanning region on the surface of the document in the sub-scanning direction.

24. The image scanning method according to claim 23, wherein the outputting further comprises:
reflecting the light output from the light source to the contact glass by a reflector such that the light substantially overlaps the scanning region onto the surface of the document in the sub-scanning direction.
